(19) United States
(12) Patent Application Publication
(10) Pub. No.: US 2005/0252977 A1
(43) Pub. Date: Nov. 17, 2005

(54) Code verification method for limited resource microcircuits

(75) Inventors: Jean-Francois Grezes, Marseille (FR); Alexandre Benoit, Marseille (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: GEMPLUS, Gemenos (FR)

(21) Appl. No.: 10/515,375

(22) PCT Filed: May 23, 2003
(86) PCT No.: PCT/EP03/50193

§ 371 Date: Jul. 15, 2005

(30) Foreign Application Priority Data
May 27, 2002 (FR) 02/06445

(51) Int. Cl. G06K 19/06

(52) U.S. Cl. 235/492

(57) ABSTRACT

The invention relates to a method of verifying an intermediary code which can be executed by a limited resource microcircuit which is connected to an external data processing system. The method includes a step involving the modification of the intermediary code comprising the reallocation of real r-type registers to monomorphic-type virtual v registers and the construction of a re-allocated code having PC instructions which refer to the virtual v registers. In addition, the method includes a step involving the verification of the reallocated code in the limited resource microcircuit. Following the successful verification of the reallocated code in the microcircuit, the original intermediary code is installed in the limited resource microcircuit for the execution thereof.

The present invention concerns a method of verifying codes used with limited-resource microcircuits, as used in chip cards, in particular for verifying integrity and ensuring the innocuousness of the code.

Electronic microcircuit cards, referred to as chip cards, are used as a mobile data processing medium for very diverse applications requiring for the majority of them a high level of security, in particular banking operations, secure payments, access to buildings or to secure areas and telecommunications. The widespread use of chip cards and the diversity of their applications tend currently to the use of open platforms, such as the platform known by the name “Java”, which allows the loading, into the memory of an electronic-data processing machine, of applications compatible with the platform. A platform such as Java has two advantages, standardisation of the intermediate code, referred to as the “bytecode”, and its independence with respect to the machine. Any Java program can therefore be compiled in a series of bytecode instructions universally understood by any machine based on such a platform.

Given that smart cards or other on-board systems are mobile and are used in relation to foreign data processing systems, or execute an either unknown or non-secure original bytecode, it is necessary to verify the integrity and innocuousness of the program used with the card or with other on-board systems.

A program for verifying intermediate code of the Java type is described in the patent U.S. Pat. No. 5,740,441. The verification method described in this patent is adapted to data processing systems such as PC computers where the calculating power of their processor and the capacity of their random access memory RAM (Random Access Memory) are appreciably greater than those of a chip card. The power of the processor and the capacity of the random access memory or of the permanent memory ROM (Read Only Memory) depend on the surface area of the embedded silicon. Since the chip cards have on the one hand to comply with mechanical constraints, in particular torsion and flexion, and on the other hand to guarantee a reasonable service life, their silicon surface does not generally exceed 25 mm². The memory of a chip card typically has a capacity of approximately 8 kilobytes, consequently much less than the RAM capacity available to the PC computer with the lowest performance currently offered on the market.

There exist several solutions for verifying the bytecode in devices whose memory capacity is very limited.

One of these approaches consists of adding to the code the result of a precalculation algorithm which will then be taken up again by the bytecode verifier. It may be a case for example of the PCC (Proof Carrying Code) method or a variant of the latter which enables the embedded checker to use simpler algorithms. A program, such as any Java applet, does not include the supplementary PCC code, and will therefore not be able to be verified by the microcircuit. The sphere of use of microcircuits using these methods is therefore limited.

Another approach consists of modifying the intermediate code of the program to be verified outside the device so that the verification method is easier without for all that giving rise to a reduction in reliability, as described in International patent application WO 0114958 A2. In this application, a method of verifying a program of the Java type is described in which the intermediate code is modified by a so-called “normalisation” method in an external data processing system before transferring this modified code into an on-board system. During this normalisation, the real register of types is reallocated to a virtual register, each box in this register defining only a type, that is to say the virtual register is monomorphic. This modification therefore makes it possible to greatly reduce the memory consumption necessary for storing the various types of a polymorphous register during the verification method. If the method of verifying this modified code ends with success, the modified code is then executed by the on-board system. One of the disadvantages of this method is that it is not possible to be absolutely sure that the modified code in the external system corresponds to the original code and will be executed correctly by the on-board system. Moreover, executing a modified code according to the method described in the aforementioned patent application limits the use of certain calculation optimisation techniques of the program.

In general terms, the conventional methods of verifying the Java intermediate code (bytecode) intended to be used in limited-resource microcircuits can also have the drawbacks of increasing the quantity of information to be transmitted to the microcircuits, requiring the implementation and execution of relatively complex software in the external data processing system in communication with the chip card, or limiting the use of certain calculation optimisation techniques of the program.

Having regard to the above, one of the objectives of the invention is to provide a method of verifying an intermediate code intended to be executed in an object with a limited-resource microcircuit, which is reliable and economical in terms of occupation of the memory resources of the microcircuit, in particular the volatile memory or other memories accessible in read or write mode of the microcircuit.

It is advantageous to provide a verification method intended to be executed in an object with a limited-resource microcircuit which does not compromise the execution of the intermediate code and which does not limit the use of techniques for optimising the calculation of the intermediate code.

It is advantageous to provide a verification method intended to be executed in an object with a limited-resource microcircuit, having a broad spectrum of use for a given platform, such as Java or variants such as Javacard.

It is also advantageous to reduce the use of the calculation resources of the microcircuit of the object.

It is also advantageous to reduce the time necessary for effecting the verification of a program to be verified.

The aims of the invention are achieved by a method according to claim 1.

In the present invention, a method of verifying intermediate codes which can be executed by a limited-resource microcircuit connected to an external data processing system comprises a step of modifying the intermediate code comprising the reallocation of real registers of types to virtual registers of monomorphic types, and constructing a reallocated code whose instructions make reference to the virtual registers, and a step of verifying the reallocated code in the limited-resource microcircuit, characterised in that, in the case of success with the verification of the reallocated code in the microcircuit, the original intermediate code is installed in the limited-resource microcircuit for execution.

In a first embodiment, the modification of the original intermediate code can be effected in an external data processing system before it is loaded in the limited-resource microcircuit, the modification comprising the generation of a reallocation component including a reallocation table defining the reallocation of the data of the real register type to data of the monomorphic virtual register type. In this embodiment, the verification method comprises the verification of the reallocation component and, in the case of success, the verification of the reallocated code, the reallocated code being constructed either during the method of verifying the reallocation component or after verification of the reallocation component. If the verification of the reallocated code ends with success, the original bytecode is installed for execution, the original bytecode being either stored in a permanent memory accessible in read and write mode of the microcircuit, or loaded from the external system. In the latter case, in order to ensure that the original bytecode installed from the external system corresponds to the original code which was verified during the first loading of the original bytecode, the calculation of hashing of the original intermediate code is carried out and compared with the result of the hashing calculation of the original intermediate code to be reinstalled after the verification method.

In another embodiment, the steps of calculating the reallocation and construction of the reallocated code can be carried out in the limited-resource microcircuit, the original intermediate code being loaded into the microcircuit before the verification method is executed and stored in a memory of the microcircuit, for example in a permanent memory accessible in read and write mode, of the EEPROM type (Electrically Erasable Programmable Read Only Memory).

Advantageously, the generation of a reallocated code for verification makes it possible to generate a register of the monomorphic type reducing the consumption of the volatile memory of the microcircuit during the verification of the intermediate code. The installation of the original intermediate code for execution, after the verification method, does however make it possible to avoid any problems related to the execution of a modified intermediate code and also allows the use of optimised calculation techniques.

Other advantageous characteristics of the invention will emerge from the claims, the detailed description of embodiments of the invention given below and the accompanying drawings, in which:

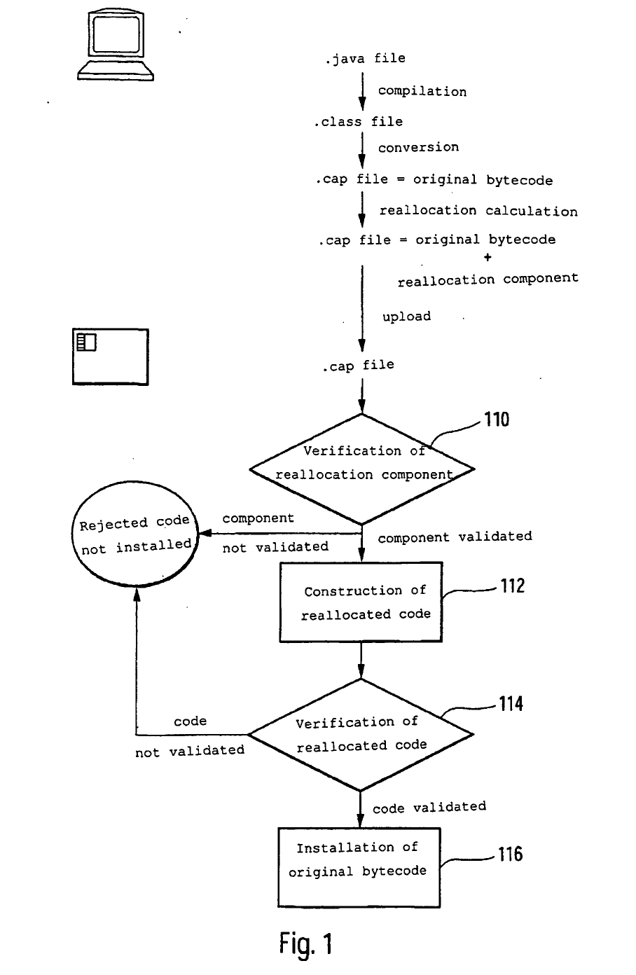

FIG. 1 shows a flow diagram illustrating the concatenation of the steps of an intermediate code verification method according to a first embodiment of the invention;

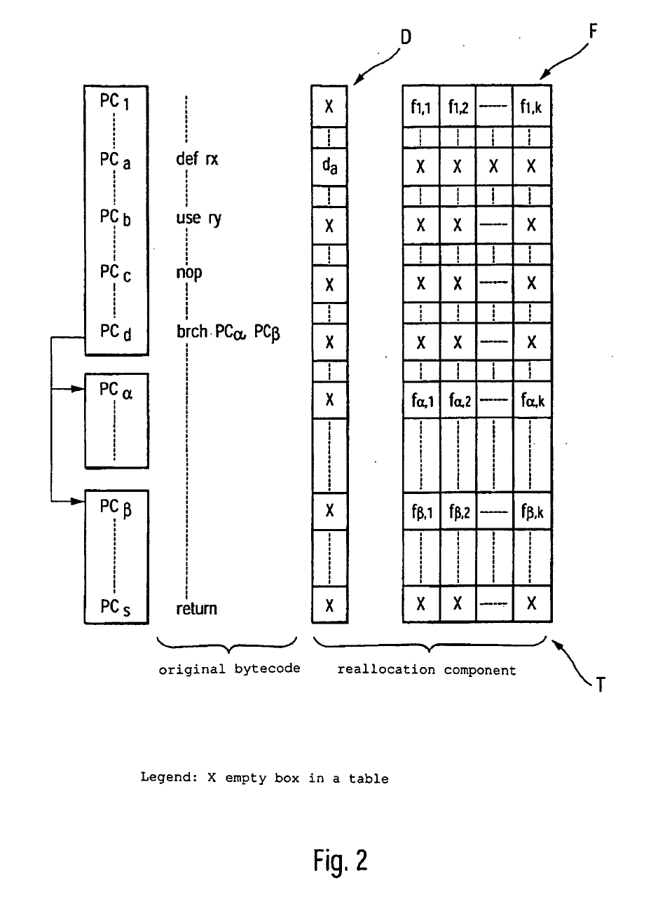

FIG. 2 is a simplified representation of instructions of the intermediate code (bytecode) and of a reallocation table associated with the instructions of the intermediate code;

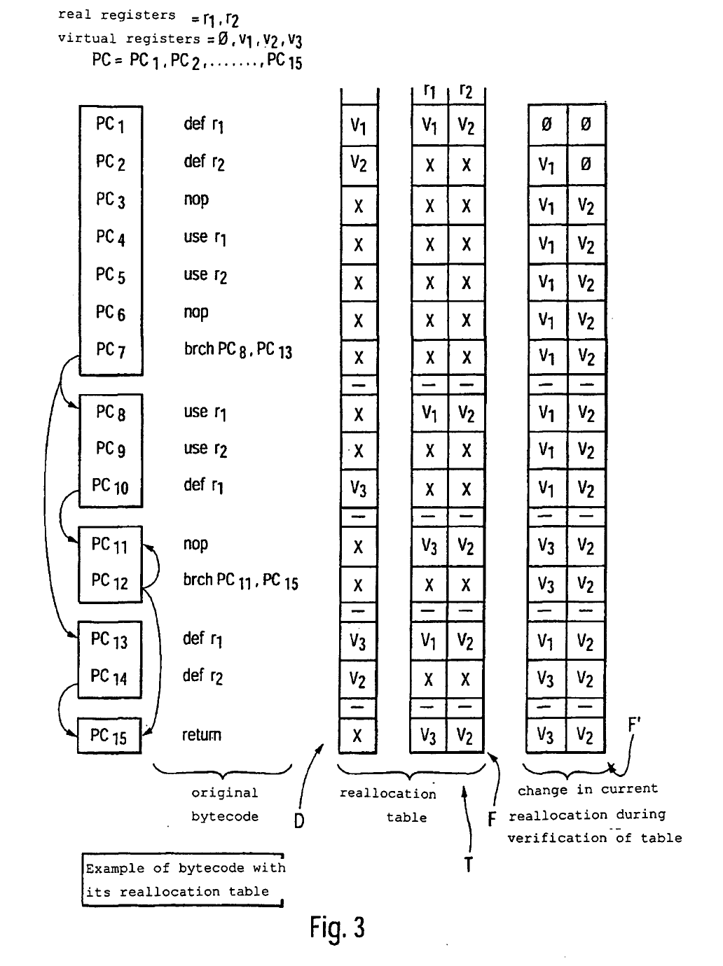

FIG. 3 is a simplified representation of an example of an intermediate code with its reallocation table in one embodiment of the invention;

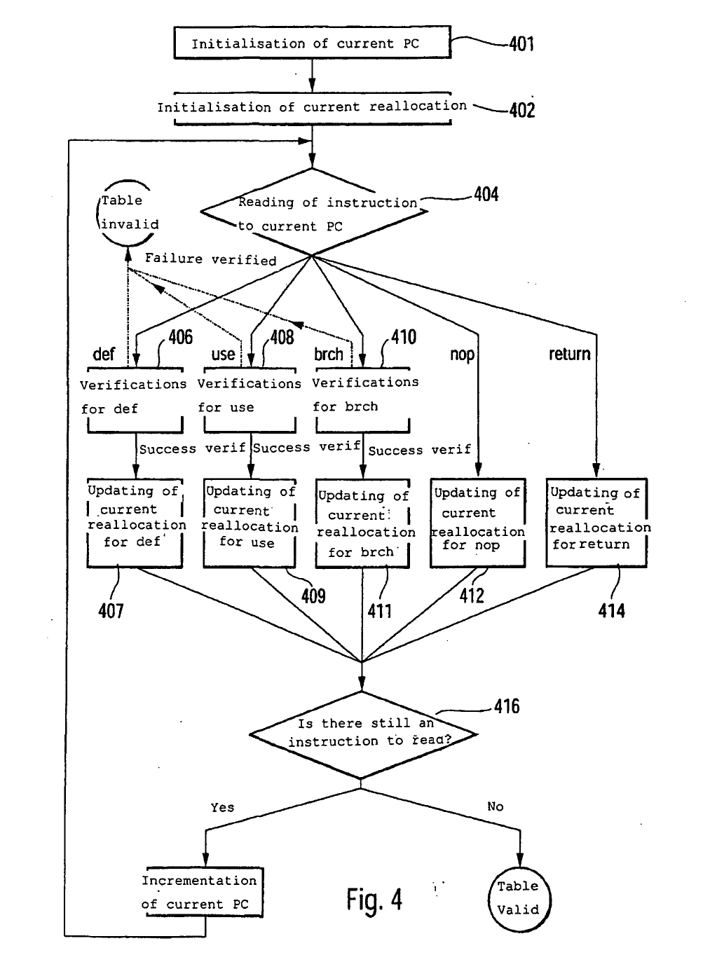

FIG. 4 shows a flow diagram illustrating the concatenation of the steps during the method of verifying the reallocation table;

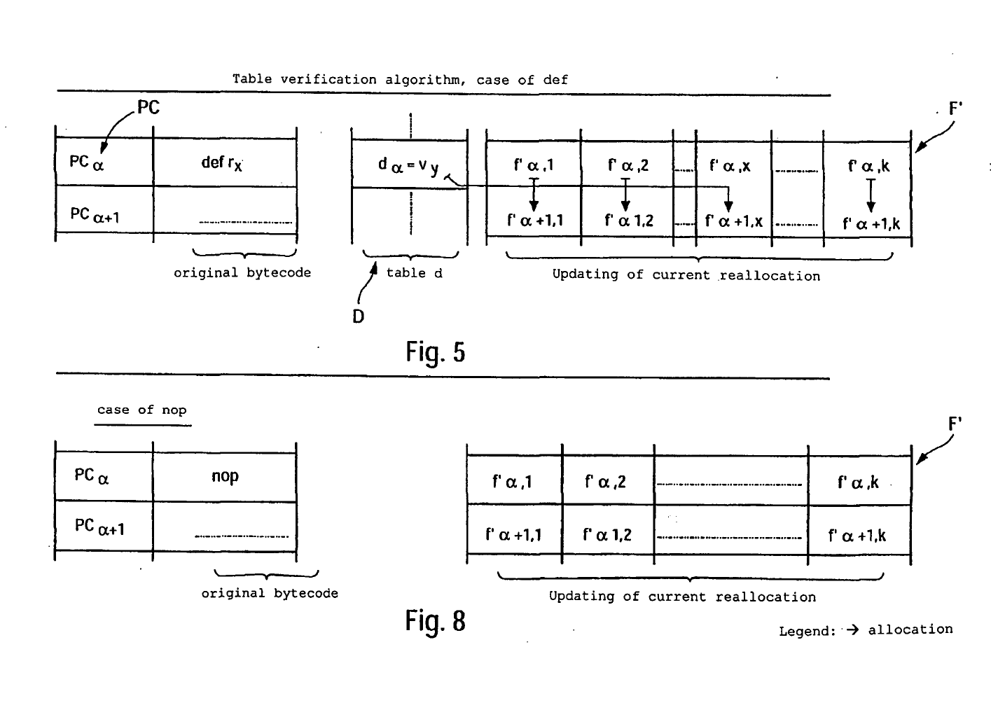

FIG. 5 is a simplified representation of the allocation and an updating of the current reallocation table for an instruction of the intermediate code and of the “def r” type, which is an instruction defining a value in the real register associated with the instruction;

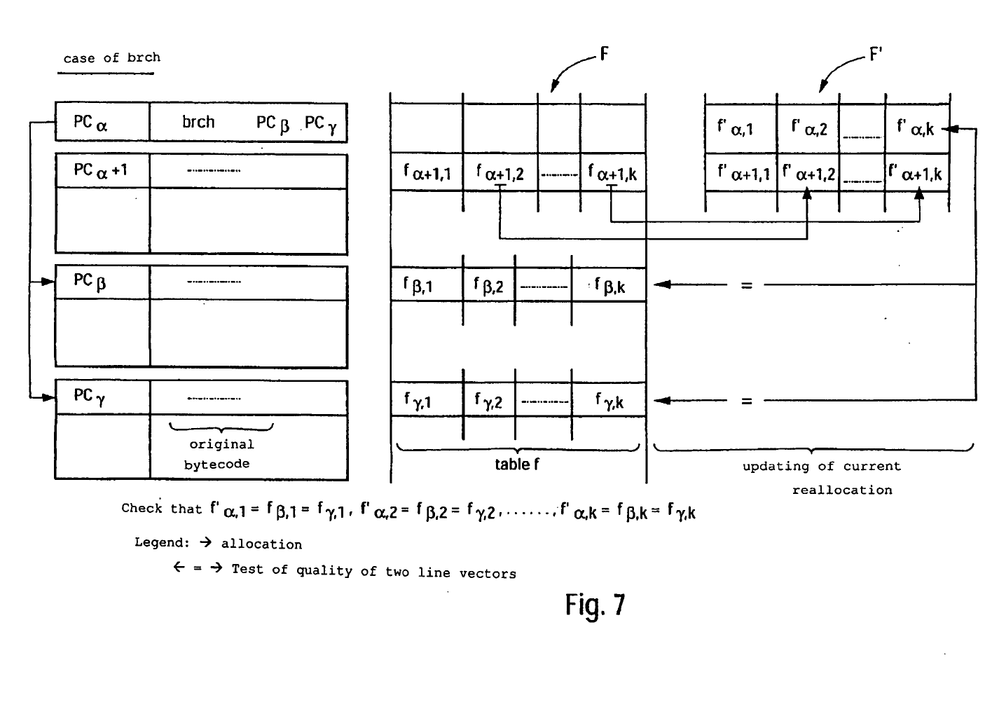

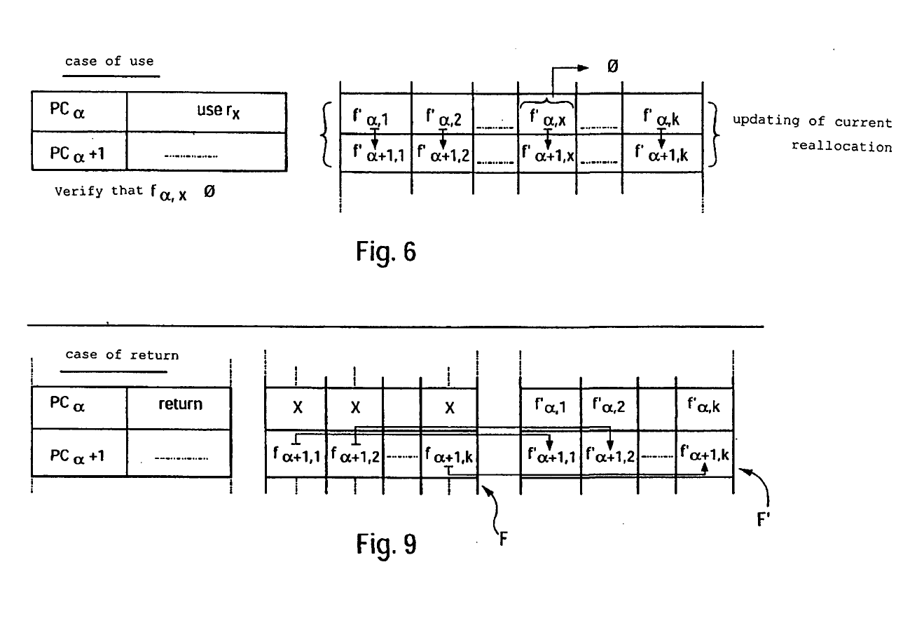

FIG. 6 is a simplified representation of the allocation and updating of the current reallocation table for an instruction of the “use r” type, which is an instruction using a value r in a register associated with the current instruction;

FIG. 7 is a simplified representation of the allocation and updating of the current reallocation table for an instruction of the intermediate code of the “brch” type, which is an instruction for switching to at least two instructions;

FIG. 8 is a simplified representation of the allocation and updating of the current reallocation table for an instruction of the “nop” type, which is an instruction which does not include any operation on the register associated with the current instruction;

FIG. 9 is a simplified representation of the allocation and updating of the current reallocation table for an instruction of the “return” type;

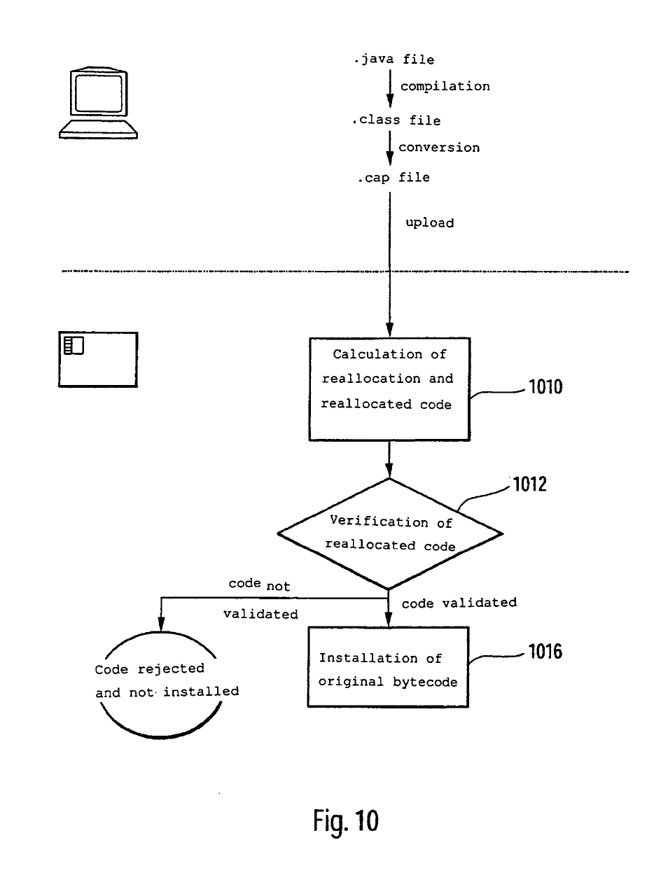

FIG. 10 shows a flow diagram illustrating the concatenation of the steps in an intermediate code verification method according to a second embodiment of the invention.

Referring to FIG. 1, the steps of a method of verifying an intermediate code, such as a Java or Javacard bytecode, according to a first embodiment of the invention, are shown. A limited-resource microcircuit, in particular for an on-board system such as a chip card, is connected to an external data processing system (hereinafter referred to as the “external system”) for loading and executing a program such as a Java or Javacard applet, in the microcircuit. The external system effects the compilation and conversion of the Java program into a file cap, that is to say the intermediate code (bytecode) executable by the microcircuit.

In this first embodiment, there is added to the original intermediate code a reallocation component comprising a reallocation table T, as shown in FIGS. 2 and 3. This reallocation component is generated by the external system by a known reallocation calculation method, such as the “graph colouring” method.

Reallocation calculation by graph colouring is well known as it stands and is used for example in the verification method described in the International application WO 0114958 A2. However, in the aforementioned application, the original intermediate code is modified by a so-called “normalisation” method. Thus, on the one hand, the instructions of the intermediate code and the register are modified, so that the register is monomorphic, that is to say each register receives data representing only one type and, on the other hand, at each switching instruction, the stack is empty. This transformation makes it possible to make the verification method linear and to avoid the high consumption of volatile memory (RAM) necessitated by the storage of registers able to accept data representing different types, that is to say polymorphous registers.

In the aforementioned known method, the Java bytecode thus modified is used for the execution of the program after verification. The execution of the modified code on the one hand can have consequences on the reliability of the execution, and on the other hand it limits the possibilities of using the known optimisation techniques of the Java bytecode, used for example for reducing the execution time or the communication time with the external system.

In the present invention, the original intermediate code (bytecode) as well as the reallocation component is loaded into the limited-resource microcircuit. The original intermediate code is stored in the memory of the microcircuit, for example in a permanent memory accessible in read and write mode of the EEPROM type, and the reallocation component is loaded into a volatile memory (RAM) of the microcircuit. After loading, the reallocation component is checked (step 110) and, in the case of success, the construction of the reallocated code (step 112) is proceeded with and finally a step of verifying the reallocated code (step 114) before the installation of the original intermediate code stored in the permanent memory (step 116) for execution. In the case of failure of the method of verifying the reallocation component or of the method of verifying the reallocated code, the intermediate code is rejected and is not installed for execution. It should be noted that the construction of the reallocated code can be effected during the method of verifying a reallocation component, that is to say steps 110 and 112 can be merged.

The procedure for verifying the reallocation component will be described in more detail below, referring to FIGS. 2 to 9:

FIG. 2 shows, in a simplified manner, a series of instructions PC of the intermediate code as well as a reallocation component T of the real register of type data. The instructions of the intermediate code can be classified amongst the following five classes of instructions according to their effect on the reallocation of the corresponding type data register.
“def x”: The value of the variable x in the register (for example the instructions “sstore”, “astore”) is defined
“use x”: x is used in the register (for example the instructions “sload”, “aload”)
“nop”: no operation is performed on the register values (for example the instructions “sxor”, “iadd”)
“return”: exit from the method (for example the instructions “areturn”, “sreturn”)
“brch x y”: Target instructions x or y are switched to (for example the instructions “ifeq”, “ifscmpeq”)

Referring more particularly to FIGS. 2 and 3, the reallocation component T comprises a sub-table D containing the reallocation for each instruction which defines the type of a variable x in the register rₓ, that is to say an instruction of the class “def x”, and a reallocation table F having the same number of columns k as real registers and the same number of lines S as instructions PC. The table F is a table resulting from the reallocation of real data registers of type rₓ to virtual registers v_{y}. Each register rₓ of the same type is reallocated to a single virtual register v_{y} corresponding to this type. The real registers, whose type may change, that is to say the polymorphous registers, are reallocated to various virtual registers corresponding to the various types of these registers. As each virtual register defines only one type, the virtual registers are monomorphic, that is to say the variables for which there exists a type remains valid throughout the intermediate code verification.

The verification algorithm is much more simple in the case of monomorphic variables, because it is simply necessary to find, for each variable, the type of variable which will be valid throughout the verification procedure. It is a case in fact of a fixed point calculation where the type of the variables is specialised until it remains unchanged. Such an algorithm fails if polymorphous variables are presented to it as being monomorphic variables.

The procedure for verifying the reallocation component uses a current table F′ (see FIG. 3) containing the type of each variable for the current instruction (PC), so that the types contained in this current table F′ correspond to the change in the current reallocation during the verification of the reallocation component T. The current table F′ can therefore be represented by a single row and a number of columns equal to the number k of real registers.

At the start of the verification method, that is to say at the instruction PC₁, the data in the current reallocation table are initialised (step 402 of FIG. 4) with the type “nil”, as shown in FIG. 3, which is the smallest element of the trellis of types, instead of the type “top”, which combines all the types, that is to say the largest element in the trellis of types. Next the first instruction is read (step 404 of FIG. 4) and, according to the instruction class of the intermediate code, a verification is carried out followed by an updating of the current reallocation table F′ or simply an updating of the current reallocation table.

For the instructions without operation on the register “nop” and return “return”, the verification algorithm simply performs an updating of the reallocation table (steps 412 and respectively 414 in FIG. 4), as shown in FIGS. 8 and respectively 9. In the case of an instruction of the “nop” type, the updating consists simply of a transfer of the type data (f′_{α, i}) into the current reallocation table, that is to say the type data are kept without change for the next instruction PC₊₁. In the case of a class instruction “return”, the updating consists of the allocation of the type data (f′_{α+1, i}) of the reallocation sub-table F of the following instruction PC₊₁ in the current allocation table F′, as shown in FIG. 9.

In the case of a definition instruction “def”, the type data (d_{α}) in the sub-table D containing the reallocation for the instruction (PC) in question are allocated to the corresponding register of the current reallocation table F′, that is to say if the current instruction PC defines the value of a register (f, ₓ) the reallocation (d_{α}=v_{y}) defined in Table D is allocated and updates the register (f′, ₓ) of the current reallocation table F′. During this updating, the other values (f′, ᵢ to f′, ₓ₋₁ and f′, ₓ₊₁ to f′, ₖ) of the current reallocation table are kept, as shown in FIG. 5.

If the instruction is of the class “use rₓ”, the verification algorithm simply checks whether the value of the corresponding register (column x) of the current reallocation table F′ is equal to the value “nil”, which is the smallest value of the trellis of types. The updating for this instruction is simply the keeping of the type data (f′, ᵢ) of the current reallocation table F′, as shown in FIG. 6.

In the case of a switching instruction, the verification consists of comparing the type data (f′, ᵢ) in the table in the current reallocation table F′ corresponding to the current instruction PC_{α} with the type data (f′, ᵢ) of the reallocation table F with the target instructions PC_{β} and PC_{γ} and, in the case of inequality, the verification procedure ends with a failure. The current reallocation table F′ is then updated by allocating the type data of the reallocation table F to the following instruction PC_{α+1} to the current reallocation table F′.

The next step (416) consists of checking whether there still remain instructions to be read and, in the affirmative, of incrementing the pointer of the current instruction (step 418) and repeating the loop of reading the instruction (step 414) and verifying and updating the current reallocation until there are no longer any instructions to be read. The verification program then passes to the step of constructing the reallocated code (step 112) and to the verification of the reallocated code (step 114). The verification of the reallocated code follows the known verification method. It should however be noted that the reallocated code can be constructed during the verification of the reallocation component (step 110) by changing the variable on which the instruction acts to its reallocated value. For example, if a definition instruction “def r₁” (see FIG. 3) acts on the register r₁ which is reallocated to the virtual register v₁, then the instruction of the reallocated code becomes “def V₁”, so that it acts on the virtual type data register instead of the real original type data register.

It is therefore found that the instructions are read linearly from the first to the last instruction, each instruction being executed by the type interpreter.

For the instructions for use of a variable (“use”), without any operation on the registers (“nop”) or return operation (“return”), the behaviour of the verification algorithm is similar to that of a conventional checker.

However, it is necessary to guarantee, during a use instruction “use x” that the variable “x” on which this instruction acts has indeed been defined previously, whilst the variable may have been initialised in another branch of the program before this instruction. This problem is resolved by verifying that the value stored in the sub-table D for a definition instruction “def x” specialises the previous type of the variable x in the current reallocation table F′. For this reason it is important that, at the start of the program, the variables of the table F′ be initialised to “nil” to enable them to be specialised.

It should be noted that, on a switching instruction “brch”, the verification algorithm makes no change to the current reallocation table F′ and advances by one instruction.

Once it has arrived at the end of the intermediate code, the program recommences at the start until the type of each variable remains unchanged. The verification algorithm fails when a code is presented to it with non-monomorphic variables since it verifies on the definition instructions “def” that the type data in the sub-table D specialise the type already present in the current reallocation table F′. A code which passes the monomorphic verification and initialises the type data of its variables must be correctly typed, since each virtual register (vᵢ) can contain only one type. In other words, the type interpreter verifies that all the possible uses of a variable are in accordance with its type and this is therefore ensured by the fact that the operations of the instructions PC on the reallocation table F pass a monomorphic verification.

A reallocation is valid if in the original intermediate code any use instruction “use x” uses the same reallocation as all the definition instructions “def x” which have been able to define it. That is to say in the code generated for the verification, if an instruction “use x” has been transformed into “use y”, then the instruction “def x” has been transformed into “def y”.

The validity of the above proposition can be demonstrated by a reductio ad absurdam. Let there be a non-valid reallocation for which the algorithm terminates on the end of the code. If the reallocation is not valid, there then exists an instruction “use x” in the field of an instruction “def x” for which the reallocation of the variable x is the variable z, whilst the reallocation of the variable x for the instruction “def x” is the variable y, where the variable y is different from the variable z. There exists a sequence of instructions of the original intermediate code “def x”, “i-1”, “i-2” . . . , “i-k”, “use x” which leads to the instruction “def x” to “use x” through a stream of correct executions. There is no other instruction “def x” within the sequence, otherwise it would be it which defines the instruction “use x”. All the other instructions preserve the current reallocation of the register x during the running of the algorithm. This is because the instructions “nop”, “return” and “use” do not change the current reallocation and the switch instruction “brch” ensures that the reallocation after the switching is the same as the one before.

The aforementioned sequence of instructions is therefore in contradiction to the reductio ad absurdam which demonstrates the validity of the initial proposition, the object of the demonstration.

It is also possible to demonstrate by the following reason that, if an intermediate code generated from an original intermediate code and from its valid reallocation table passes a verification process, then the original intermediate code also passes the verification process. Let us assume that, in the process of verifying the intermediate code, there are stored in volatile memory (RAM) the types of the variables for each switching target as well as a current table and a working list. The tables are initialised with the type “top”, the largest element of the trellis of types. The current table is also initialised with the type “top” for each non-parameterised variable and with the types of the signature for the parameterised variables. The verification algorithm commences with the instruction associated with the entry point of the method in the working list. The first instruction is removed from the working list. The new current table is calculated after the execution of this instruction from the type interpreter and is unified with all the tables which correspond to the instructions which may succeed. The instructions for which the tables have changed are added to the working table. The intermediate code is verified successfully if an empty working list is arrived at. The verification method rejects an algorithm if a unification of types is impossible or if the type interpreter encounters an instruction incompatible with the type data in the table of registers.

By taking any step of the verification of the original intermediate code, there is the hypothesis that the verification has taken place correctly up to the present time, and the current table and the content of the registers are available. The starting point is also from the assumption that the corresponding step of the verification of the intermediate code with reallocation takes place correctly and it is known that the reallocation is valid. In order to end this demonstration, several cases according to the current instruction are distinguished:
“nop”: The instruction does not concern the variables, the following instruction is passed to without modifying anything. The verification process cannot fail on an instruction “nop”.
“def x”: Updating of the current table with the new type. The verification process cannot fail on a “def” since it takes an argument from the stack, but there is no concern with the types in the stack.
“return”: The verification continues normally. The verification process cannot fail here.
“use x”: The verification process may fail if the type interpreter decides that the type of the variable x is not compatible with its use. The validity of this reallocation assures us that the reallocation of the variable x has not changed between this instruction “use” and the instructions “def” which correspond to it. As the verification of the reallocated code has succeeded up to here, the type of the variable x is compatible with its use. The verification process therefore successfully passes onto the instruction.
“brch x y”: The verification process may fail in the unification of the current table with the one corresponding to the register x or with the one corresponding to the register y. However, the validity of the reallocation assures us that the current reallocation at the time of the switching instruction “brch” is the same as that in terms of x and y. In addition, the verification of the reallocated code succeeds for this instruction, the verification therefore also succeeds for the non-reallocated intermediate code.

With regard to the processing of the exceptions in the intermediate code, if on a part of the code protected by an exception “handler”, each instruction must be considered as a potential switching to the intermediate code portion which processes the exception, that is to say the current reallocation must be the same as that given in the exception reallocation table. Though this processing of the exceptions makes it possible to ensure the correction of the typing, it is on the other hand too restrictive in the sense that it does not make it possible to change the reallocation of a variable within a block protected by one and the same exception handler. Example:
PC 1: def r₁ as an integer: reallocation r₁→v₁
PC 2: def r₁ as a reference: reallocation r₁→v₂

If the two instructions “def” are protected by the same exception “handler” and the variable r₁ is not used in the processing of the exception, then the typing is respected but the verification algorithm of the reallocation table fails since the variable r₁ can have only one reallocation at the input of the exception processing. The solution is to create an artificial register (called the Top) which prevents the use of the real register reallocated at the Top. In the example, it suffices to reallocate to Top the register r₁ in the table of reallocation of the processing of the exception. A reallocation to Top is transmitted by the switchings and can appear in a reallocation table which corresponds to the start of the processing of an exception.

With regard to invocations of sub-routines, it is necessary to take account of the fact that they cause the link between the instructions “use” and the instructions “def” of the variables to be lost. To make the reallocations compatible with the invocations of sub-routines JSR/RET, it is necessary to add a reallocation context system.

Referring to FIG. 10, in a second embodiment of the invention, the calculation of the reallocation and of the reallocated code (step 1010) is performed entirely in the limited-resource microcircuit, followed by a step 1012 of verification of the reallocated code in the microcircuit and, in the case of success, the installation of the original intermediate code for execution (step 1016). The calculation of the reallocation and of the reallocated code in the microcircuit can be made according to known methods, however without its being necessary to effect an optimisation of the reallocated code because it is not used for the execution, but solely for the verification of the integrity and innocuousness of the intermediate code.

The intermediate code can be either stored in permanent memory accessible in read and write mode, for example of the EEPROM type, at the time of the first loading from the external system, or be installed after verification, applying a hash function to the first loading, storing the result in the memory of the microcircuit and comparing it with the hash value calculated from the intermediate code loaded after verification.

1. A method of verifying an intermediate code executable by a limited-resource microcircuit connected to an external data processing system, comprising a step of modifying the intermediate code by reallocating real registers of type r to virtual registers v of monomorphic type, and constructing a reallocated code whose instructions refer to the virtual registers v, and a step of verifying the reallocated code in the limited-resource microcircuit, wherein in the case of success of the verification of the reallocated code in the microcircuit, the original intermediate code is installed in the limited-resource microcircuit for execution.

2. A method according to claim 1, wherein the step of constructing the reallocated code is performed in the limited-resource microcircuit.

3. A method according to claim 1, wherein the original intermediate code is loaded into the limited-resource microcircuit before the execution of the verification method and stored in a memory of the microcircuit.

4. A method according to claim 1, wherein in the step of modifying the intermediate code, a reallocation component T is created defining the reallocation of the real type registers to the monomorphic virtual registers.

5. A method according to claim 4, wherein the reallocation component T contains a reallocation sub-table D containing the reallocation for each definition instruction “def” of the intermediate code defining the type of a variable in one of the real registers, and a reallocation table F containing the reallocation of the real type registers to the monomorphic virtual registers.

6. A method according to claim 5, wherein during the process of verifying the reallocation component T, a verification is made whether the reallocation sub-table D for the definition instructions “def” contains a reallocation value and, if it does not contain any reallocation value, the intermediate code is rejected.

7. A method according to claim 5, wherein during the process of verifying the reallocation table F, for an instruction of the intermediate code which uses a variable, it is verified whether the variable used in the current reallocation table is not “nil” and, if it is “nil”, the intermediate code is rejected.

8. A method according to claim 5, wherein during the process of verifying the reallocation table in the context of a switch instruction “brch” to target instructions, the identity of the current reallocation table F′ is verified with the rows of the reallocation table F corresponding to the target instructions and, in the case of differences, the intermediate code is rejected.

9. A method according to claim 1, wherein the step of modifying the intermediate code is performed in the limited-resource microcircuit.

10. A method according to claim 2, wherein the step of modifying the intermediate code is performed in the limited-resource microcircuit.

11. A method according to claim 3, wherein the step of modifying the intermediate code is performed in the limited-resource microcircuit.
